(19) United States
(12) Patent Application Publication
(10) Pub. No.: US 2007/0000743 A1
(43) Pub. Date: Jan. 4, 2007

(54) Adjustable damping force hydraulic shock absorber

(75) Inventors: Tutomu Naitou, Saitama (JP); Katsushi Tanaka, Saitama (JP); Kazunari Maeda, Saitama (JP)

Correspondence Address: BABCOCK IP, PLLC, P.O.BOX 488, 4934 WILDWOOD DRIVE, BRIDGMAN, MI, 49106, US

(73) Assignee: Showa Corporation, Saitama (JP)

(21) Appl. No.: 11/301,375

(22) Filed: Dec. 13, 2005

(30) Foreign Application Priority Data
Jun. 29, 2005 (JP) 2005-190516

(51) Int. Cl. F16F 9/54

(52) U.S. Cl. 188/322.2

(57) ABSTRACT

A damping force adjustable hydraulic shock absorber is provided with a first passage connected to a rod side chamber, a second passage connected to a piston side chamber, a main passage combining the first passage and the second passage so as to communicate with a reservoir, a first check valve allowing only an oil flow to the main passage from the rod side chamber via the first passage, and a second check valve allowing only an oil flow to the main passage from the piston side chamber via the second passage, and a proportional solenoid type relief valve provided in the main passage, and adjusting a damping force by controlling a relief pressure of the oil flow to the reservoir from the rod side chamber or a relief pressure of the oil flow to the reservoir from the piston side chamber.

### BACKGROUND OF THE INVENTION

1. Field of the Invention

The present invention relates to an adjustable damping force hydraulic shock absorber.

2. Description of the Related Art

A hydraulic shock absorber used in a suspension apparatus of a motor vehicle or the like has an adjustable damping force which may be adjusted for improved ride quality and steering stability in correspondence to a road surface condition, a traveling condition or the like.

A hydraulic shock absorber in Japanese Patent Application Laid-open No. 9-303471 (patent document 1) has a cylinder receiving an oil, a piston rod inserted to the cylinder, a piston connected to the piston rod and sectioning a rod side chamber and a piston side chamber in an inner portion of the cylinder, and a reservoir sealing the oil and a gas. Further, the hydraulic shock absorber has a first passage connected to the rod side chamber, a second passage connected to the piston side chamber, a main passage combining the first passage and the second passage so as to communicate with the reservoir, a first check valve allowing only an oil flow to the main passage from the rod side chamber via the first passage, and a second check valve allowing only an oil flow to the main passage from the piston side chamber via the second passage. Accordingly, the hydraulic shock absorber circulates the oil in the rod side chamber to the reservoir via the first passage and the main passage at a time when the piston rod is elongated, and circulates the oil in the piston side chamber to the reservoir via the second passage and the main passage at a time when the piston rod is compressed, thereby setting oil supply and discharge directions in the cylinder to different directions in a push pull stroke.

The hydraulic shock absorber of patent document 1 is structured such that the damping force can be adjusted by controlling both of the oil flowing to the reservoir from the rod side chamber via the first passage and the main passage at a time when the hydraulic shock absorber is elongated, and the oil flowing to the reservoir from the piston side chamber via the second passage and the main passage at a time when the hydraulic shock absorber is compressed, by a single pilot type damping force adjusting valve provided in the main passage.

In the hydraulic shock absorber of patent document 1, because the oil supply and discharge directions in the cylinder are set to the different directions in the push pull stroke, it is possible to enlarge a pressure receiving area in the compression side to a cross sectional area of the cylinder without enlarging the size of the cylinder and the piston rod, in comparison with the structure in which the supply and discharge directions are set to one direction in the push pull stroke. Further, since it is not necessary to enlarge the diameter of the piston rod, it is possible to increase the pressure receiving area in the elongation side.

However, in the hydraulic shock absorber of patent document 1, because the damping force adjusting valve is the pilot type, in addition to the structure in which the oil supply and discharge directions in the cylinder are set to the different directions in the push pull stroke, the structure of the hydraulic pipe path becomes complicated, the number of the constituting parts such as an orifice, a check valve and the like is increased, and it is difficult to assemble them.

### SUMMARY OF THE INVENTION

An object of the present invention is to simplify a structure of a hydraulic pipe path, in a hydraulic shock absorber in which oil supply and discharge directions in a cylinder are set to different directions in a push pull stroke, and which is provided with a single damping force adjusting valve.

The present invention relates to an adjustable damping force hydraulic shock absorber comprising: a cylinder receiving an oil; a piston rod inserted to the cylinder; a piston connected to the piston rod and sectioning a rod side chamber and a piston side chamber in an inner portion of the cylinder; and a reservoir sealing the oil and a gas. Furthermore, the adjustable damping force hydraulic shock absorber comprises: a compression side passage having a compression side check valve allowing only an oil flow to the rod side chamber from the reservoir; an elongation side passage having an elongation side check valve allowing only an oil flow to the piston side chamber from the reservoir; a first passage connected to the rod side chamber, a second passage connected to the piston side chamber, and a main passage combining the first passage and the second passage so as to communicate with the reservoir; a first check valve allowing only an oil flow to the main passage from the rod side chamber via the first passage, and a second check valve allowing only an oil flow to the main passage from the piston side chamber via the second passage; and a proportional solenoid type relief valve provided in the main passage, and adjusting a damping force by controlling a relief pressure of the oil flow to the reservoir from the rod side chamber or a relief pressure of the oil flow to the reservoir from the piston side chamber.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a general cross sectional view showing a hydraulic shock absorber;

FIG. 2 is a cross sectional view of a main portion in FIG. 1;

FIG. 3 is a cross sectional view showing a hydraulic circuit of the hydraulic shock absorber;

FIG. 4 is a cross sectional view showing a flow in a compression stroke;

FIG. 5 is a cross sectional view showing a flow in an elongation stroke; and

FIG. 6 is a hydraulic circuit diagram.

### DESCRIPTION OF THE PREFERRED EMBODIMENTS

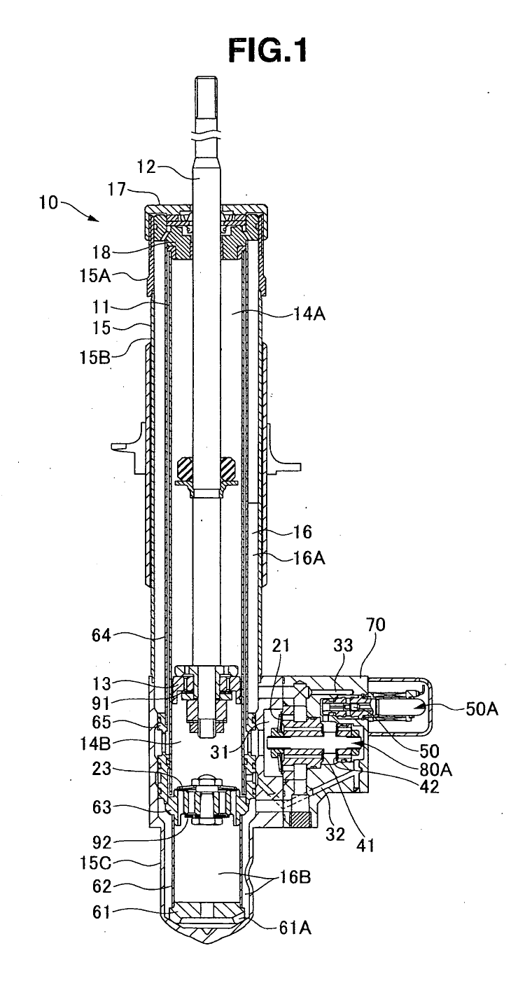

A hydraulic shock absorber 10 has a cylinder 11 receiving an oil, a piston rod 12 inserted to the cylinder 11, and a piston 13 connected to the piston rod 12 and sectioning a rod side chamber 14A and a piston side chamber 14B in an inner portion of the cylinder 11, as shown in FIG. 1. Further, an outer tube 15 is provided in an outer periphery of the cylinder 11 via an annular gap, and a reservoir 16 sealing an oil and a gas is formed in the outer tube 15.

The hydraulic shock absorber 10 is structured such that a cap 17 is attached to an upper end portion of the outer tube 15, and a rod guide 18 is pinched between the cap 17 and an upper end portion of the cylinder 11. The rod guide 18 seals the rod side chamber 14A and the reservoir 16, and slidably supports the piston rod 12 while being provided with an oil seal and a dust seal.

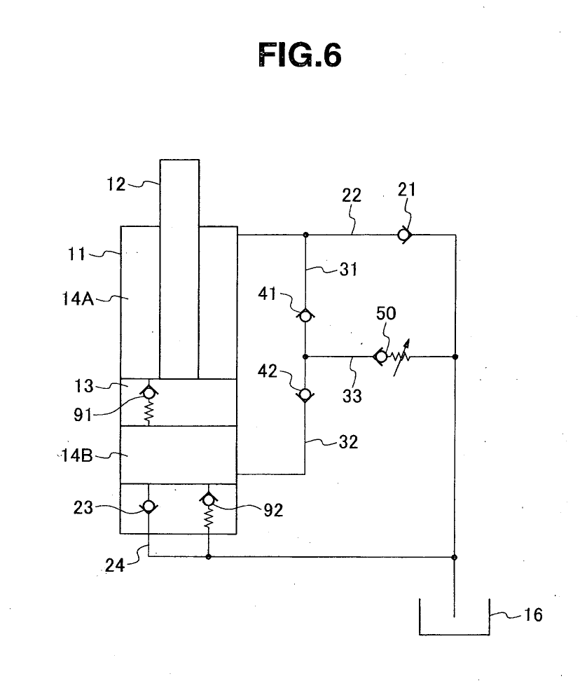

The hydraulic shock absorber 10 has a compression side passage 22 having a compression side check valve 21 allowing only an oil flow to the rod side chamber 14A from the reservoir 16, and makes it possible to supply the oil to the rod side chamber 14A from the reservoir 16 in the compression stroke, as shown in FIG. 6. Further, the hydraulic shock absorber 10 has an elongation side passage 24 having an elongation side check valve 23 allowing only an oil flow to the piston side chamber 14B from the reservoir 16, and makes it possible to supply the oil to the piston side chamber 14B from the reservoir 16 in the elongation stroke.

The hydraulic shock absorber 10 has a first passage 31 connected to the rod side chamber 14A, a second passage 32 connected to the piston side chamber 14B, and a main passage 33 combining the first passage 31 and the second passage 32 so as to communicate with the reservoir 16, as shown in FIG. 6. Further, the hydraulic shock absorber 10 has a first check valve 41 allowing only an oil flow to the main passage from the rod side chamber 14A via the first passage 31, and a second check valve 42 allowing only an oil flow to the main passage 33 from the piston side chamber 14B via the second passage 32, and sets oil discharge directions to the reservoir 16 from the cylinder 11 (the rod side chamber 14A and the piston side chamber 14B) to different directions in both of the compression stroke and the elongation stroke.

The hydraulic shock absorber 10 is provided with a damping force adjusting valve 50 in the main passage 33. The damping force adjusting valve 50 adjusts a damping force by controlling the oil flow to the reservoir 16 from the rod side chamber 14A, or the oil flow to the reservoir 16 from the piston side chamber 14B. The damping force adjusting valve 50 in accordance with the present embodiment has a proportional solenoid type relief valve which adjusts the damping force by controlling a relief pressure of the oil flow to the reservoir 16 from the rod side chamber 14A, or a relief pressure of the oil flow to the reservoir 16 from the piston side chamber 14B.

A description will be given below of a particular structure for arranging the compression side check valve 21, the elongation side check valve 23, the first passage 31, the second passage 32, the main passage 33, the first check valve 41, the second check valve 42 and the damping force adjusting valve 50 in the hydraulic shock absorber 10.

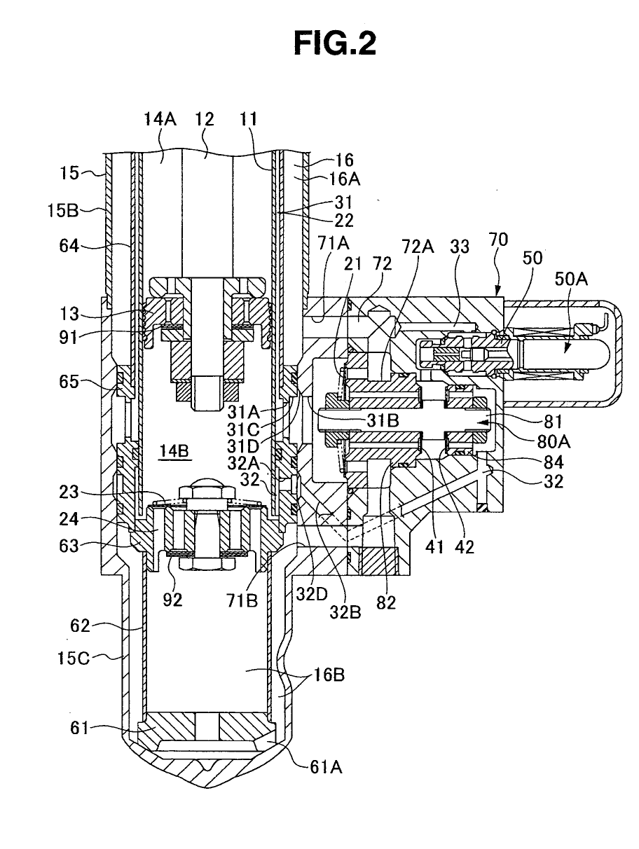

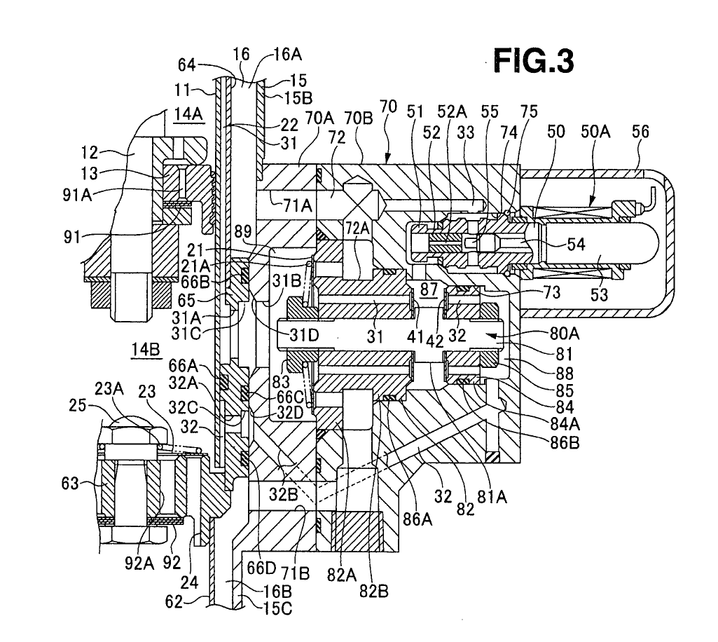

The hydraulic shock absorber 10 is structured, as shown in FIGS. 2 and 3, such that a bottom piece 61 is seated on a bottom portion of the outer tube 15, a spacer tube 62 and a partition base 63 are pinched between the bottom piece 61 and a lower end portion of the cylinder 11 within a lower end inner peripheral space (the reservoir 16) of the outer tube 15. Inner and outer spaces of the spacer tube 62 are always conducted with each other by a communication path 61A provided in the bottom piece 61, and the inner and outer spaces of the space tube 62 are formed as a part of the reservoir 16 mentioned above. In this case, the outer tube 15 is separated into three sections comprising an upper outer tube 15A, an intermediate outer tube 15B and a lower outer tube 15C, and the lower outer tube 15C has a part of a valve housing 70 mentioned below.

The hydraulic shock absorber 10 is provided with a communication tube 64 in an outer periphery of the cylinder 11 via a small annular gap, and a separator 65 in a lower end outer periphery of the cylinder 11. In the outer periphery of the cylinder 11, the first passage 31 (also forming the compression side passage 22) is connected to the rod side chamber 14A and the second passage 32 is connected to the piston side chamber 14B in an extending manner, and the separator 65 separates the first passage 31 and the second passage 32. In other words, the hydraulic shock absorber 10 has a communication tube 64 in the outer side of the cylinder 11 and the first passage 31 (the compression side passage 22) is formed in the outer periphery of the cylinder 11 surrounded by the communication tube 64. An inner periphery of an upper portion of the separator 65 is fitted to an outer periphery of a lower portion of the communication tube 64, and an inner periphery of a lower portion of the separator 65 is fitted to an outer periphery of the lower portion of the cylinder via an O-ring 66A. The first passage 31 in the outer periphery of the cylinder 11 surrounded by the communication tube 64 is communicated with first intermediate communication paths 31A provided at a plurality of positions (for example, four positions) in a peripheral direction of the separator 65, and the second passage 32 in the outer periphery of the cylinder 11 surrounded by the separator 65 is communicated with second intermediate communication paths 32A provided at a plurality of positions (for example, four positions) in a peripheral direction of the separator 65. In this case, an upper end portion of the communication tube 64 is fitted to the outer periphery of the rod guide 18 mentioned above, a lower end portion of the separator 65 is fitted to an outer periphery of the partition base 63 mentioned above, and the communication tube 64 and the separator 65 are pinched between the rod guide 18 and the partition base 63.

In the hydraulic shock absorber 10, since the separator 65 is provided in the outer periphery of the cylinder 11 at a time of forming the reservoir 16 by the outer tube 15 provided in the outer periphery of the cylinder 11, the reservoir 16 is sectioned into upper end lower reservoirs 16A and 16B by the separator 65, and the upper and lower reservoirs 16A and 16B can be communicated by a reservoir communication flow path 72 provided in a valve housing 70 mentioned below.

In the hydraulic shock absorber 10, the valve housing 70 is fitted to the outer periphery of the cylinder 11 and the separator 65. The valve housing 70 is provided with a closed-end tubular lower outer tube 15C integrally formed therewith, an inner periphery of the lower outer tube 15C is fitted to an outer periphery of the separator 65 provided in the outer periphery of the cylinder 11 via O-rings 66B, 66C and 66D while putting the lower outer tube 15C on the periphery of the partition base 63, the space tube 62 and the bottom piece 61 coupled to the cylinder 11 and the separator 65 in the manner mentioned above, an upper end portion of the lower outer tube 15C is fitted to an outer periphery of a lower end of the intermediate outer tube 15B, and the bottom piece 61 seated on the bottom portion of the lower outer tube 15C is brought into contact with the lower end portion of the spacer tube 62.

The valve housing 70 is constituted by a first housing 70A integrally provided with the lower outer tube 15C, and a second housing 70B, and is provided with the compression side check valve 21, the compression side passage 22, the first passage 31, the second passage 32, the main passage 33, and the damping force adjusting valve 50. The compression side passage 22 and the first passage 31 are partially commonly used.

The valve housing 70 (the lower outer tube 15C) is provided with a first intermediate communication port 31B for the first passage 31 (the compression side passage 22), and a second intermediate communication port 32B for the second passage 32 so as to be open to a fitting surface to the separator 65 in the inner periphery of the lower outer tube 15C. When the valve housing 70 (the lower outer tube 15C) is fitted to the outer periphery of the separator 65 and the outer periphery of the lower end of the intermediate outer tube 15B, each of the first intermediate communication path 31A for the first passage 31 and the second intermediate communication path 32A for the second passage 32 which are provided in the separator 65, is communicated with each of the first intermediate communication port 31B for the first passage 31 and the second intermediate communication port 32B for the second passage 32 which are provided in the valve housing 70, by each of first annular passages 31C and 31D and second annular passages 32C and 32D which are continuously recessed in an entire periphery of at least one of an outer periphery of the separator 65 and an inner periphery of the valve housing 70 (the lower outer tube 15C), both in the present embodiment.

The valve housing 70 (the lower outer tube 15C) is provided with an upper connection port 71A to the upper reservoir 16A, a lower connection port 71B to the lower reservoir 16B, and a reservoir communication flow path 72 connecting the upper end lower connection ports 71A and 71B. The upper and lower connection ports 71A and 71B are open to upper and lower sides with respect to the fitting surface to the separator 65 in the inner periphery of the lower outer tube 15C. The main passage 33 is communicated with the reservoir communication flow path 72. When fitting the valve housing 70 (the lower outer tube 15C) to the outer periphery of the separator 65 and the outer periphery of the lower end of the intermediate outer tube 15B, the upper connection port 71A in the valve housing 70 is directly open to the upper reservoir 16A, and the lower connection port 71B is directly open to the lower reservoir 16B.

The hydraulic shock absorber 10 is structured such that a damping force adjusting valve unit 50A is received in the valve housing 70, and a check valve unit 80A in which the first check valve 41, the second check valve 42 and the compression side check valve 21 may be sub-assembled on a single axis is received in the valve housing 70.

The check valve unit 80A is structured such that a first valve body 82 is attached to a lower position of an intermediate flange 81A of a valve shaft 81 by a nut 83, and a second valve body 84 is attached to an upper position of the intermediate flange 81A by a nut 85. The first check valve 41 and the compression side check valve 21 are provided in both surfaces of the first valve body 82, and the second check valve 42 is provided in one surface of the second valve body 84. The first check valve 41 is constituted by a disc in which an inner peripheral side is pinched between the first valve body 82 and the intermediate flange 81A, and opens and closes the first passage 31 provided in the first valve body 82. The compression side check valve 21 is constituted by a disc which is backed up by a valve spring 21A supported by the nut 83, and opens and closes the compression side passage 22 provided in the first valve body 82. The second check valve 42 is constituted by a disc that is pinched between the second valve body 84 and the intermediate flange 81A, and opens and closes the second passage 32 provided in the second valve body 84. An annular concave portion 72A forming a part of the reservoir communication flow path 72 is provided in an outer periphery of the first valve body 82.

The check valve unit 80A is inserted to an attachment hole 73 pierced in the second housing 70B of the valve housing 70 (open to an attachment mating face to the first housing 70A in the second housing 70B), an outer periphery of the first valve body 82 is inserted and attached to the attachment hole 73 via an O-ring 86A, and an outer periphery of the second valve body 84 is inserted and attached to the attachment hole 73 via an O-ring 86B. The check valve unit 80A forms a main passage confluence portion 87 where the first passage within the first valve body 82 and the second passage 32 within the second valve body 84 flow together, between the first valve body 82 and the second valve body 84, in an inner portion of the attachment hole 73, and forms a second passage approach portion 88 to which the second passage 32 within the valve housing 70 (70A, 70B) is open, in a space opposite to the first valve body 82 in the second valve body 84.

When the second housing 70B to which the check valve unit 80A is inserted is attached to the attachment mating face of the first housing 70A, the valve shaft 81 of the check valve unit 80A, the nut 83 and the like are received in a supply and discharge chamber 89 recessed in the attaching mating face of the first housing 70A, and the outer peripheral portion of the first valve body 82 is held so as to be brought into contact with the attachment mating face of the first housing 70A. The supply and discharge chamber 89 is communicated with the compression side passage 22 (the first passage 31) in the cylinder 11 side via the first intermediate communication port 31B of the valve housing 70. The first valve body 82 forms a partition wall 82A sectioning the supply and discharge chamber 89 communicating with the compression side passage 22 (the first passage 31) in the cylinder 11 side and the reservoir communication flow path 72, and can open and close the compression side passage 22 within the partition wall 82A by the compression side check valve 21. Further, the first valve body 82 forms a partition wall 82B (the O-ring 86A) sectioning the supply and discharge chamber 89 and the main passage mating portion 87, and can open and close the first passage 31 within the partition wall 82B by the first check valve 41. The second valve body 84 forms the partition wall 84A sectioning the second passage approach portion 88 and the main passage mating portion 87, and can open and close the second passage 32 within the partition wall 84A by the second check valve 42.

The damping force adjusting valve unit 50A is structured such that a valve box 51 of the damping force adjusting valve 50 is inserted to the valve chamber 74 pierced in the second housing 70B of the valve housing 70 (which is open to a surface in an opposite side to the attachment mating face to the first housing 70A, and is adjacent in parallel to the attachment hole 73 for the check valve unit 80A, in the second housing 70B), and the valve body 51 is held in the second housing 70B by a retaining ring 75 so as to be prevented from coming off. The valve body 51 inserted to the valve chamber 74 travels back and forth so as to traverse an intermediate portion of the main passage 33 in the second housing 70B. The valve body 51 has a valve seat 52 with a passage 52A creating a path between main passage 33 and main passage confluence portion 87 as the valve body 51 travels back and forth. The damping force adjusting valve 50 opens and closes the passage 52A of the valve seat 52 by moving the valve body 55 connected to an operation rod 54 of a solenoid actuator 53 close to or apart from the valve seat 52, the solenoid actuator 53 opens the passage 52A, and a valve opening pressure (a relief pressure) conducting the main passage 33 is controlled by changing a set current of the solenoid actuator 53. Reference numeral 56 denotes a cover for the solenoid actuator 53.

The hydraulic shock absorber 10 is provided with the elongation side check valve 23, and the elongation side passage 24 in the partition base 63 provided in the bottom portion side of the cylinder 11. The valve spring 23A is supported by the bolt 25 fastened to the partition base 63 and the elongation side passage 24 is opened and closed by the disc-like elongation side check valve 23 backed up by the valve spring 23A.

The hydraulic shock absorber 10 is provided with an elongation side relief valve 91 which is opened on the basis of a hydraulic pressure equal to or more than a fixed level of the rod side chamber 14A (a hydraulic pressure less than a burst pressure of the damping force adjusting valve 50) so as to circulate the oil in the rod side chamber 14A to the piston side chamber 14B, in the piston 13. The elongation side relief valve 91 opens and closes an elongation side passage 91A provided in the piston 13.

The hydraulic shock absorber 10 is provided with a compression side relief valve 92 which is opened on the basis of a hydraulic pressure equal to or more than a fixed level of the piston side chamber 14B (a hydraulic pressure less than the burst pressure of the damping force adjusting valve 50) so as to circulate the oil in the piston side chamber 14B to the rod side chamber 14A, in the partition base 63. The compression side relief valve 92 opens and closes a compression side passage 92A provided in the partition base 63.

The hydraulic shock absorber 10 operates in the following manner.

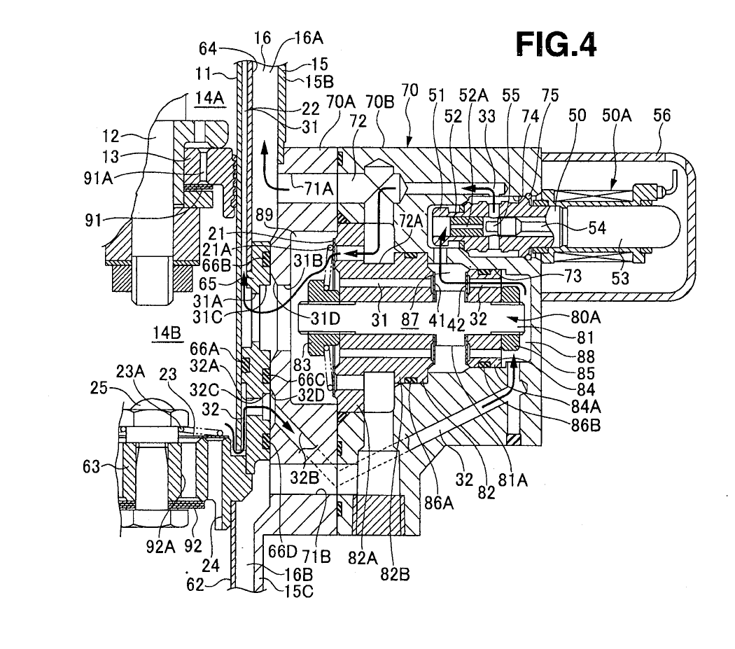

(Compression Stroke) (FIG. 4)

When the hydraulic shock absorber 10 is compressed, the cylinder 11 and the piston rod 12 are relatively compressed, and a suspension spring (not shown) is compressed. Further, the piston rod 12 goes into the cylinder 11, and the oil in the piston side chamber 14B goes into the main passage 33 from the lower end of the cylinder 11 through the second passage 32 in the cylinder 11 side, the second communication path 32A of the separator 65, the second intermediate communication port 32B of the valve housing 70, and the second passage 32 within the valve housing 70, while pushing open the second check valve 42 provided in the second valve body 84 of the check valve unit 80A. The oil going into the main passage 33 passes through the damping force adjusting valve 50 by getting over the relief pressure set in the damping force adjusting valve 50, and flows into the reservoir communication flow path 72 within the valve housing 70, and a magnitude of the damping force is adjusted on the basis of a magnitude of the set relief pressure of the damping force adjusting valve 50 therebetween. For example, in the case that an exciting current set in the solenoid actuator 53 of the damping force adjusting valve 50 is high, the relief pressure of the damping force adjusting valve 50 becomes high, and a generated damping force becomes higher. A compression speed of the suspension spring is controlled on the basis of the compression side damping force.

In this case, when the hydraulic shock absorber 10 is compressed, the oil in the reservoir 16 is replenished to the rod side chamber 14A from the upper end of the piston rod 11 via the supply and discharge chamber 89 of the valve housing 70, the first intermediate communication port 31B, the first intermediate communication path 31A of the separator 65, and the first passage 31 in the cylinder 11 side, through the compression side passage 22 by opening the compression side check valve 21 provided in the first valve body 82 of the check valve unit 80A, from the reservoir communication flow path 72 of the valve housing 70. Further, the oil corresponding to a volume at which the piston rod 12 goes into the cylinder 11 is discharged from the piston side chamber 14B, passes through the damping force adjusting valve 50 in the manner mentioned above so as to flow into the reservoir communication flow path 72, and is thereafter discharged to the upper reservoir 16A from the upper connection port 71A of the valve housing 70.

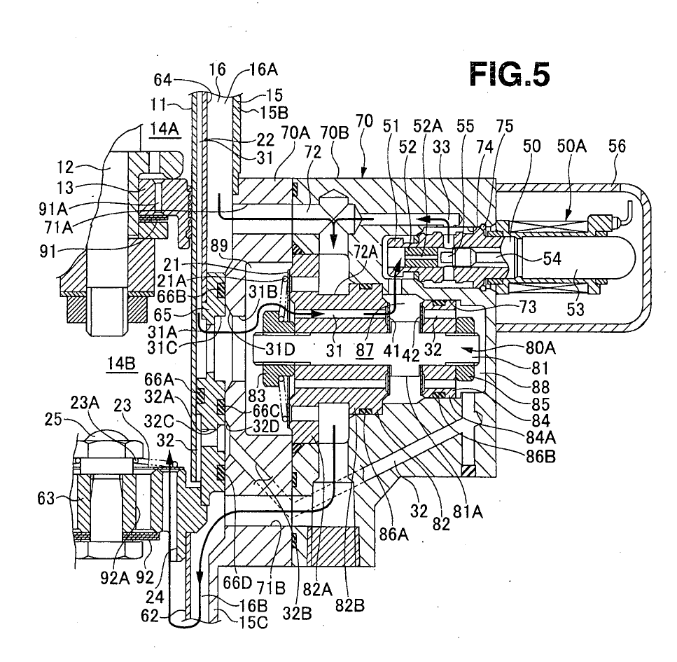

(Elongation Stroke) (FIG. 5)

When the hydraulic shock absorber 10 is elongated, the cylinder 11 and the piston rod 12 are relatively elongated, and the suspension spring (not shown) is elongated. Further, the piston rod 12 goes out of the cylinder 11, and the oil in the rod side chamber 14A goes into the main passage 33 from the upper end of the cylinder 11 through the first passage 31 in the cylinder 11 side, the first intermediate path 31A of the separator 65, the first intermediate communication port 31B of the valve housing 70, and the first passage 31 within the valve housing 70, while pushing open the first check valve 41 provided in the first valve body 82 of the check valve unit 80A. The oil going into the main passage 33 passes through the damping force adjusting valve 50 by getting over the relief pressure set in the damping force adjusting valve 50, and flows into the reservoir communication flow path 72 within the valve housing 70, and a magnitude of the damping force is adjusted on the basis of a magnitude of the set relief pressure of the damping force adjusting valve 50 therebetween. For example, in the case that an exciting current set in the solenoid actuator 53 of the damping force adjusting valve 50 is high, the relief pressure of the damping force adjusting valve 50 becomes high, and a generated damping force becomes higher. An elongation speed of the suspension spring is controlled on the basis of the elongation side damping force.

In this case, when the hydraulic shock absorber 10 is elongated, the oil in the reservoir 16 is replenished to the piston side chamber 14B through the elongation side passage 24 while opening the elongation side check valve 23 provided in the partition base 63. At this time, the oil corresponding to a volume at which the piston rod 12 goes out of the cylinder 11 is replenished to the piston side chamber 14B from the reservoir 16 through the elongation side check valve 23 and the elongation side passage 24.

In accordance with the present embodiment, the following operations and effects can be achieved.

(a) The oil in the rod side chamber 14A is circulated to the reservoir 16 via the first passage 31 and the main passage 33 at a time when the piston rod 12 is elongated, and the oil in the piston side chamber 14A is circulated to the reservoir 16 via the second passage 32 and the main passage 33 at a time when the piston 12 is compressed, whereby the supply and discharge directions of the oil in the cylinder 11 are set to the different directions in the push pull stroke. Accordingly, it is possible to increase both of the pressure receiving areas in the push pull stroke without enlarging the sizes of the cylinder 11 and the piston rod 12.

(b) The damping force can be adjusted by controlling both of the oil flowing to the reservoir 16 from the rod side chamber 14A via the first passage 31 and the main passage 33 at a time of the elongation, and the oil flowing to the reservoir 16 from the piston side chamber 14A via the second passage 32 and the main passage 33 at a time of the compression, by only one damping force adjusting valve 50 provided in the main passage 33, the damping force adjusting valve 50 employs the proportional solenoid type relief valve 50 which directly controls the hydraulic pressure of the main passage 33. Accordingly, it is possible to simplify the structure of the hydraulic pipe path, reduce the number of the constituting parts, and easily assemble.

(c) The valve housing 70 provided in the outer surface of the cylinder 11 is provided with the compression side passage 22, the compression side check valve 21, the first passage 31, the second passage 32, the first check valve 41, the second check valve 42 and the proportional solenoid type relief valve 50, and the partition base 63 provided in the bottom portion side of the cylinder 11 is provided with the elongation side passage 24 and the elongation side check valve 23. Accordingly, it is possible to easily assemble.

(d) The elongation side relief valve 91 is provided in the piston 13, the compression side relief valve 92 is provided in the partition base 63, and the valve opening pressures thereof are set less than the burst pressure of the proportional solenoid type relief valve 50. Accordingly, it is possible to protect the proportional solenoid type relief valve 50.

As heretofore explained, embodiments of the present invention have been described in detail with reference to the drawings. However, the specific configurations of the present invention are not limited to the illustrated embodiments but those having a modification of the design within the range of the presently claimed invention are also included in the present invention.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A damping force adjustable hydraulic shock absorber (10) comprising:
a cylinder (11) receiving an oil;
a piston rod (12) inserted to the cylinder (11);
a piston (13) connected to the piston rod (12) and sectioning a rod side chamber (14A) and a piston side chamber (14B) in an inner portion of the cylinder (11); and
a reservoir (16) sealing the oil and a gas,
wherein the damping force adjustable hydraulic shock absorber (10) comprises:
a compression side passage (22) having a compression side check valve (21) allowing only an oil flow to the rod side chamber (14A) from the reservoir (16);
an elongation side passage (24) having an elongation side check valve (23) allowing only an oil flow to the piston side chamber (14B) from the reservoir (16);
a first passage (31) connected to the rod side chamber (14A), a second passage (32) connected to the piston side chamber (14B), and a main passage (33) combining the first passage (31) and the second passage (32) so as to communicate with the reservoir (16);
a first check valve (41) allowing only an oil flow to the main passage (33) from the rod side chamber (14A) via the first passage (31), and a second check valve (42) allowing only an oil flow to the main passage (33) from the piston side chamber (14B) via the second passage (32); and
a proportional solenoid type relief valve (50) provided in the main passage (33), and adjusting a damping force by controlling a relief pressure of the oil flow to the reservoir (16) from the rod side chamber (14A) or a relief pressure of the oil flow to the reservoir (16) from the piston side chamber (14B).

2. A damping force adjustable hydraulic shock absorber (10) as claimed in claim 1, wherein a valve housing (70) is provided in an outer surface of the cylinder (11), and the valve housing (70) is provided with the compression side passage (22), the compression side check valve (21), the first passage (31), the second passage (32), the main passage (33), the first check valve (41), the second check valve (42) and the proportional solenoid type relief valve (50), and
wherein a partition base (63) is provided in a bottom portion side of the cylinder (11), and the partition base (63) is provided with the elongation side passage (24) and the elongation side check valve (23).

3. A damping force adjustable hydraulic shock absorber (10) as claimed in claim 1, wherein the piston (13) is provided with an elongation side relief valve (91) opened on the basis of a hydraulic pressure equal to or more than a fixed level of the rod side chamber (14A) so as to circulate the oil in the rod side chamber (14A) to the piston side chamber (14B), and
wherein the partition base (63) is provided with a compression side relief valve (92) opened on the basis of a hydraulic pressure equal to or more than a fixed level of the piston side chamber (14B) so as to circulate the oil in the piston side chamber (14B) to the rod side chamber (14A).

4. A damping force adjustable hydraulic shock absorber (10) as claimed in claim 2, wherein the piston (13) is provided with an elongation side relief valve (91) opened on the basis of a hydraulic pressure equal to or more than a fixed level of the rod side chamber (14A) so as to circulate the oil in the rod side chamber (14A) to the piston side chamber (14B), and
wherein the partition base (63) is provided with a compression side relief valve (92) opened on the basis of a hydraulic pressure equal to or more than a fixed level of the piston side chamber (14B) so as to circulate the oil in the piston side chamber (14B) to the rod side chamber (14A).

5. A damping force adjustable hydraulic shock absorber (10) as claimed in claim 1, wherein an outer tube (15) is provided in an outer periphery of the cylinder (11) via an annular gap, and the reservoir (16) is formed within the outer tube (15).

6. A damping force adjustable hydraulic shock absorber (10) as claimed in claim 2, wherein an outer tube (15) is provided in an outer periphery of the cylinder (11) via an annular gap, and the reservoir (16) is formed within the outer tube (15).

7. A damping force adjustable hydraulic shock absorber (10) as claimed in claim 3, wherein an outer tube (15) is provided in an outer periphery of the cylinder (11) via an annular gap, and the reservoir (16) is formed within the outer tube (15).

8. A damping force adjustable hydraulic shock absorber (10) as claimed in claim 4, wherein an outer tube (15) is provided in an outer periphery of the cylinder (11) via an annular gap, and the reservoir (16) is formed within the outer tube (15).

9. A damping force adjustable hydraulic shock absorber (10) as claimed in claim 5, wherein the outer tube (15) is separated into an upper outer tube (15A), an intermediate outer tube (15B) and a lower outer tube (15C),
wherein the valve housing (70) is constituted by a first housing (70A) and a second housing (70B), and
wherein the first housing (70A) is integrally provided with the lower outer tube (15C).

10. A damping force adjustable hydraulic shock absorber (10) as claimed in claim 6, wherein the outer tube (15) is separated into an upper outer tube (15A), an intermediate outer tube (15B) and a lower outer tube (15C),
wherein the valve housing (70) is constituted by a first housing (70A) and a second housing (70B), and
wherein the first housing (70A) is integrally provided with the lower outer tube (15C).

11. A damping force adjustable hydraulic shock absorber (10) as claimed in claim 7, wherein the outer tube (15) is separated into an upper outer tube (15A), an intermediate outer tube (15B) and a lower outer tube (15C),
wherein the valve housing (70) is constituted by a first housing (70A) and a second housing (70B), and
wherein the first housing (70A) is integrally provided with the lower outer tube (15C).

12. A damping force adjustable hydraulic shock absorber (10) as claimed in claim 8, wherein the outer tube (15) is separated into an upper outer tube (15A), an intermediate outer tube (15B) and a lower outer tube (15C),
wherein the valve housing (70) is constituted by a first housing (70A) and a second housing (70B), and
wherein the first housing (70A) is integrally provided with the lower outer tube (15C).

13. A damping force adjustable hydraulic shock absorber (10) as claimed in claim 1, wherein the compression side check valve (21), the first check valve (41) and the second check valve (42) are structured by a check valve unit (80A) which is sub assembled on a single axis.
